(19) United States
(12) Patent Application Publication
(10) Pub. No.: US 2024/0343077 A1
(43) Pub. Date: Oct. 17, 2024

(54) DEVICE FOR CONNECTING TO A LOAD TO BE MOVED

(71) Applicant: M-Mover Holdings Limited, Ashbourne (GB)

(72) Inventors: Owen Hughes, Ashbourne (GB); James Jones, Ashbourne (GB); Andy Owen, Ashbourne (GB)

(73) Assignee: M-Mover Holdings Limited, Ashbourne (GB)

(21) Appl. No.: 18/580,968

(22) PCT Filed: Jul. 20, 2022
(86) PCT No.: PCT/GB2022/051870

§ 371 Date: Jan. 19, 2024

(30) Foreign Application Priority Data
Jul. 22, 2021 (GB) 2110575.4

(51) Int. Cl. B60D 1/44; B60D 1/48

(52) U.S. Cl. CPC B60D 1/44; B60D 1/488

(57) ABSTRACT

A device for connecting to a load to be moved, the device including: a main body having a connection formation for engaging with a corresponding formation provided on a load moving apparatus: a connection assembly for connecting the main body to a part of the load to be moved, including: first and second engagement members for engaging with respective portions of the part of the load to be moved, an adjustment member connecting the first engagement member to the main body and providing for adjustment of the position of the first engagement member relative to the main body, a further adjustment member connecting the second engagement member to the main body and providing for adjustment of the position of the second engagement member relative to the main body.

This invention relates to a device for connecting to a load to be moved. More particularly, the invention relates to a device for connecting to a load to be moved so that said load can be moved by a load moving apparatus.

Load moving apparatus are used to move loads which may be considered to be too heavy to be safely moved by a human without assistance. In general, the load moving apparatus may be used to move many different loads, either by pushing or pulling. The load moving apparatus may be used to move a plurality of identical loads, such as a large number of heavy boxes of identical size and weight. In other examples, the load moving apparatus may be used to move a plurality of dissimilar loads, such as a large number of boxes of differing size and weight. Load moving apparatus may also be used to move loads which are very heavy, such as steel containers holding many goods, large machinery or moveable installations within factories.

One method of connecting a load moving apparatus to a load to be moved is to use a coupling. The coupling may, for example, be attached to either the load moving apparatus or the load to be moved. Alternatively, the coupling may be formed by a combination of two cooperating coupling parts, one of which is provided on the load moving apparatus and the other being provided on the load to be moved. The two parts of the coupling may, for example, be coupled by the interlocking of formations provided on each part. It is commonplace for these coupling parts to be welded to or bolted to the load moving apparatus and load to be moved, to ensure a secure connection. In situations where the load moving apparatus is to be used to move differing loads, the user must ensure that each of the loads possess a coupling part which will cooperate with the coupling part provided on the load moving apparatus.

According to a first aspect of the invention we provide a device for connecting to a load to be moved, the device including:
a main body having a connection formation for engaging with a corresponding formation provided on a load moving apparatus;
a connection assembly for connecting the main body to a part of the load to be moved, including:
   first and second engagement members for engaging with respective portions of the part of the load to be moved,
   an adjustment member connecting the first engagement member to the main body and providing for adjustment of the position of the first engagement member relative to the main body,
   a further adjustment member connecting the second engagement member to the main body and providing for adjustment of the position of the second engagement member relative to the main body.

According to a second aspect of the invention we provide a device for connecting to a load to be moved, the device including:
a main body having a connection formation for engaging with a corresponding formation provided on a load moving apparatus;
a connection assembly for connecting the main body to a part of the load to be moved, including:
   first and second engagement members for engaging with respective portions of the part of the load to be moved,
   an adjustment member for connecting the first or second engagement member to the main body and providing for adjustment of the position of the first or second engagement member relative to the main body,
   a further adjustment member connecting the first engagement member to the second engagement member and providing for adjustment of the position of the first and second engagement members relative to each other.

According to a third aspect of the invention we provide a device for connecting to a load to be moved, the device including:
a main body having a connection formation for engaging with a corresponding formation provided on a load moving apparatus;
a connection assembly for connecting the main body to a part of the load to be moved, including:
   first, second and third engagement members for engaging with respective portions of the part of the load to be moved,
   an adjustment member for connecting the first or second engagement member to the main body and providing for adjustment of the position of the first or second engagement member relative to the main body,
   a further adjustment member connecting the other of the first or second engagement member to the main body and providing for adjustment of the position of the second engagement member relative to the main body,
   a further adjustment member connecting the first or second engagement member to the third engagement member and providing for adjustment of the position of the third engagement members relative to the engagement member to which it is connected.

Further features of the first and second aspects of the invention are set out in the claims appended hereto.

Embodiments of the invention will now be described, by way of example only, with reference to the following figures, of which:

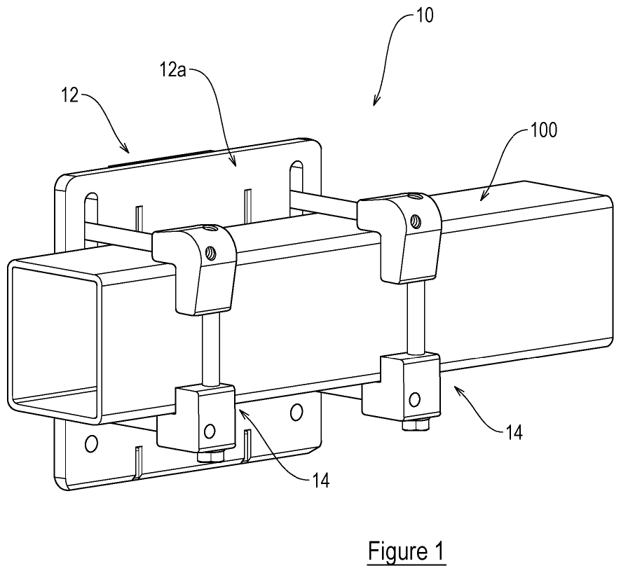

FIG. 1 is a front perspective view of a device according to the present invention;

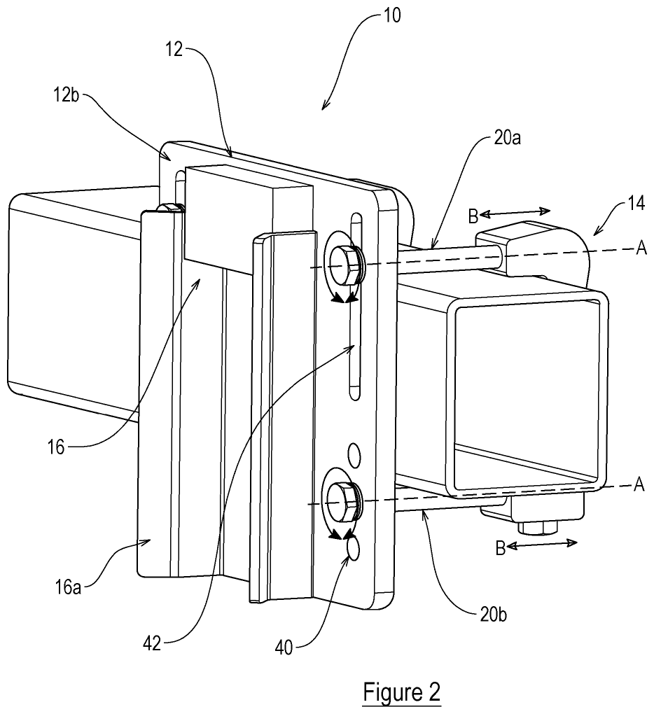

FIG. 2 is a rear perspective view of a device according to the present invention;

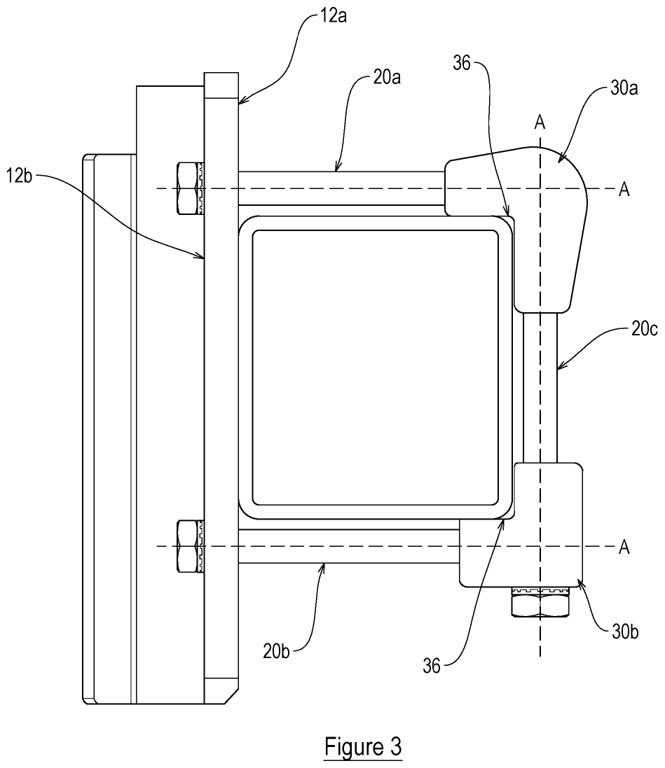

FIG. 3 is a side view of a device according to the present invention;

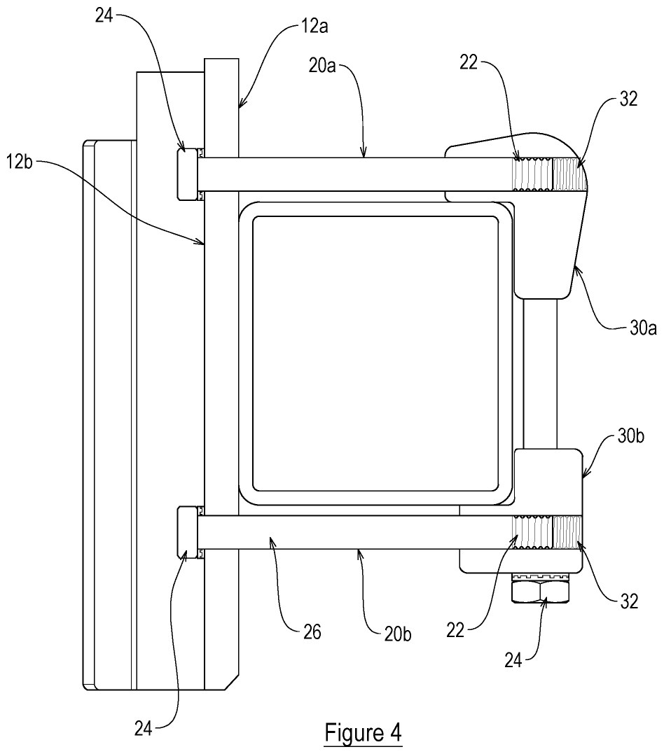

FIG. 4 is a side section view of a device according to the present invention;

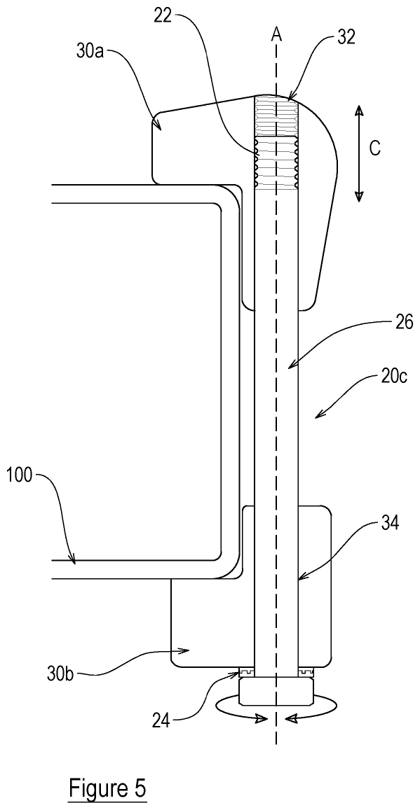

FIG. 5 is a side section view of a part of a device according to the present invention;

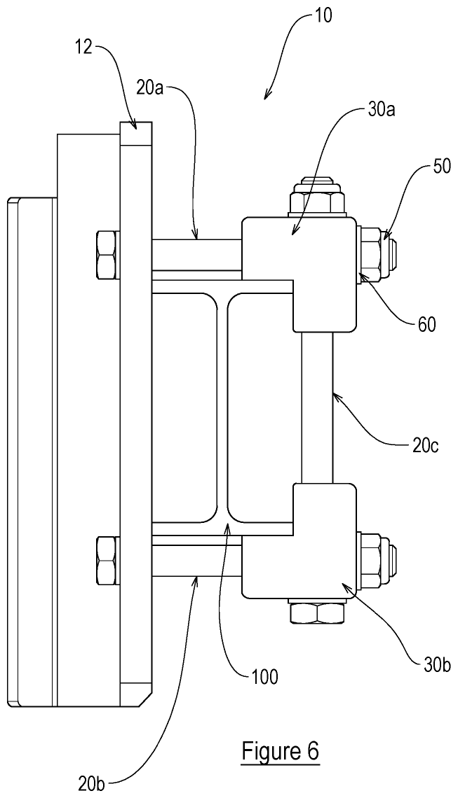

FIG. 6 is a side view of a device according to the present invention;

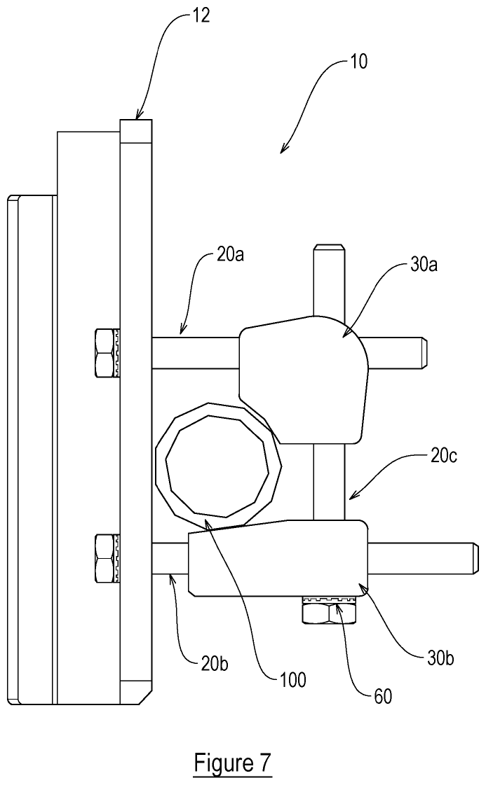

FIG. 7 is a side view of a device according to the present invention;

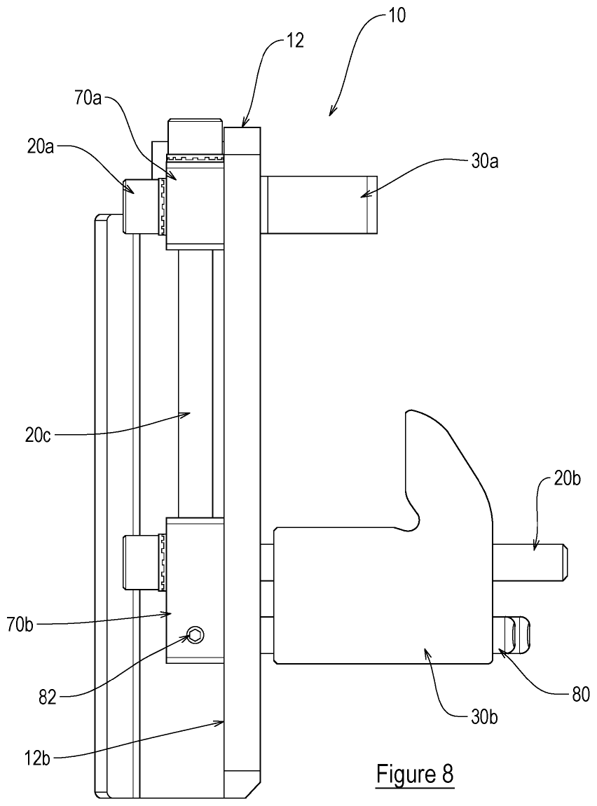

FIG. 8 is a side view of a device according to the present invention;

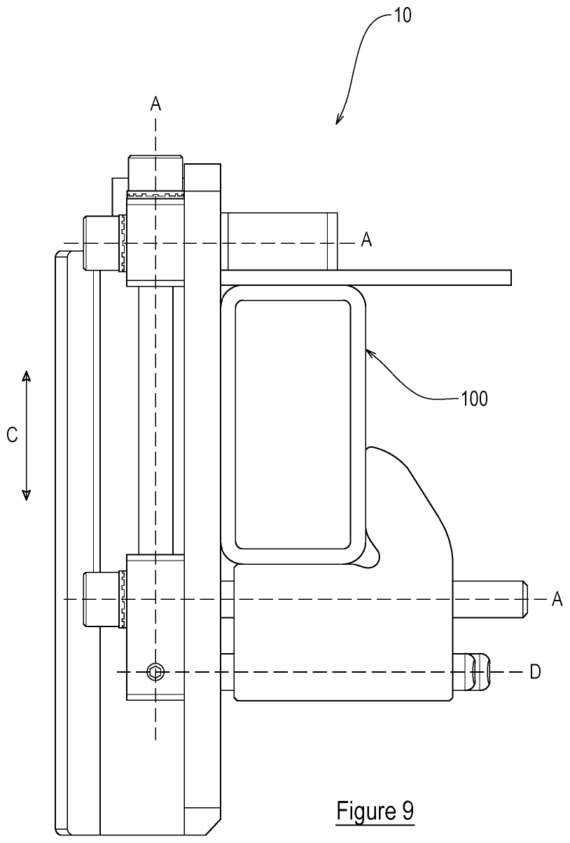

FIG. 9 is a side view of a device according to the present invention;

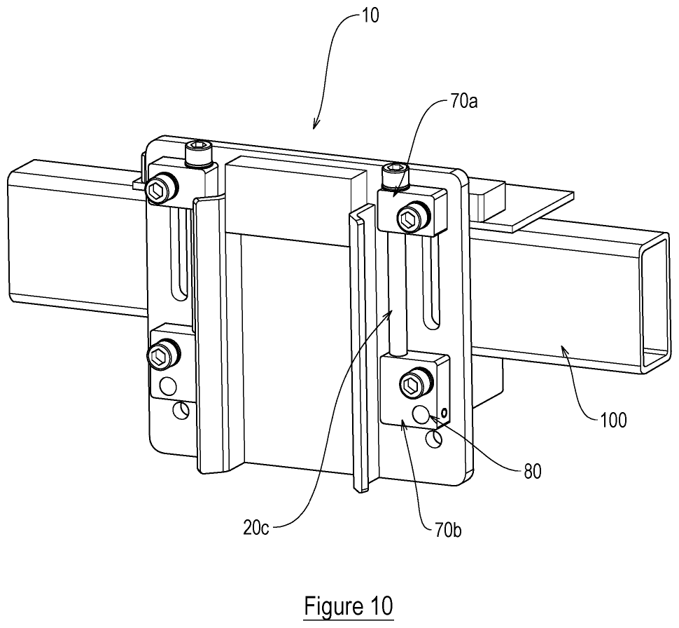

FIG. 10 is a rear perspective view of a device according to the present invention;

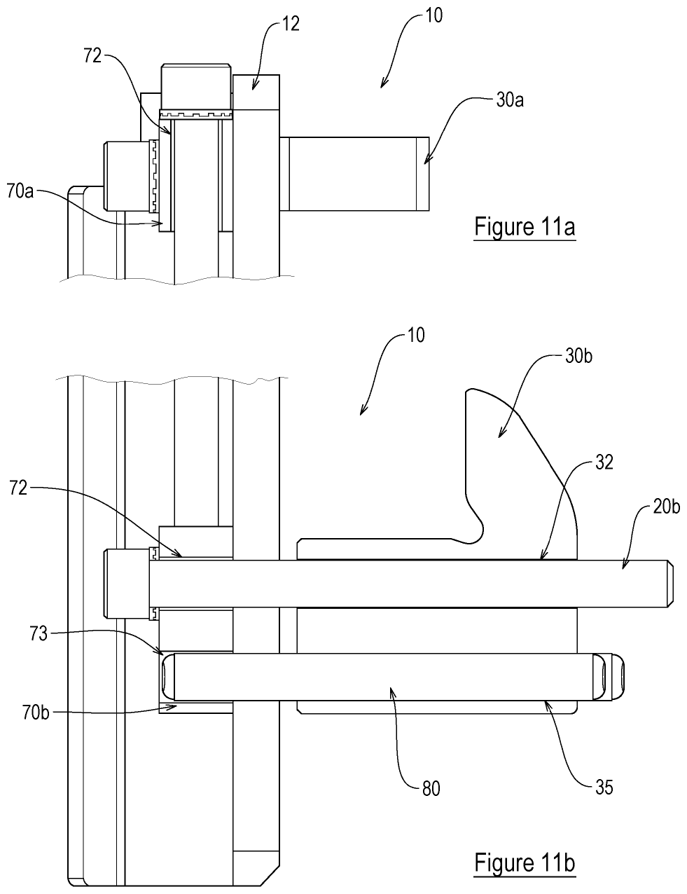

FIG. 11a is a side section view of a part of a device according to the present invention;

FIG. 11b is a side section view of a part of a device according to the present invention;

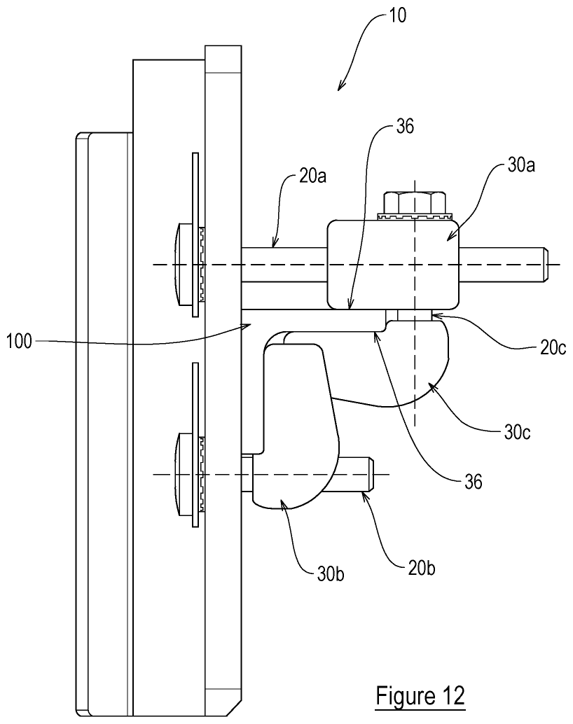

FIG. 12 is a side view of a device according to the present invention;

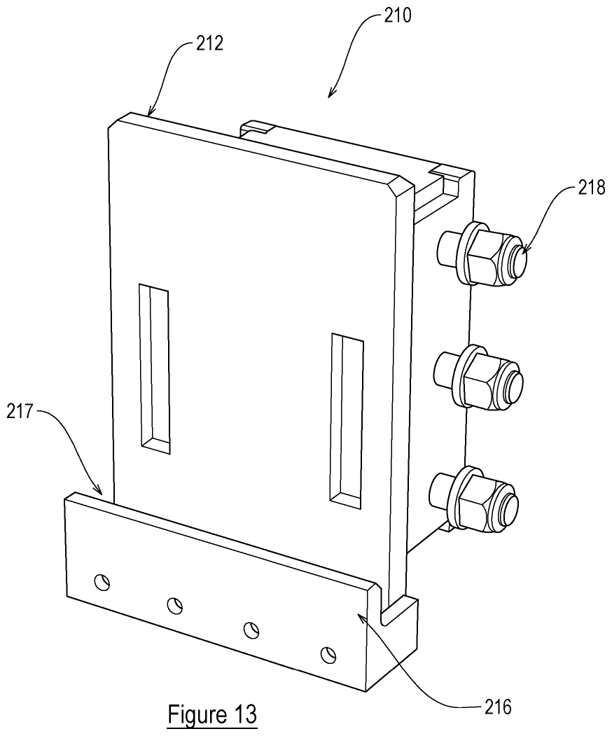

FIG. 13 is a perspective view of a part for use with a device according to the present invention;

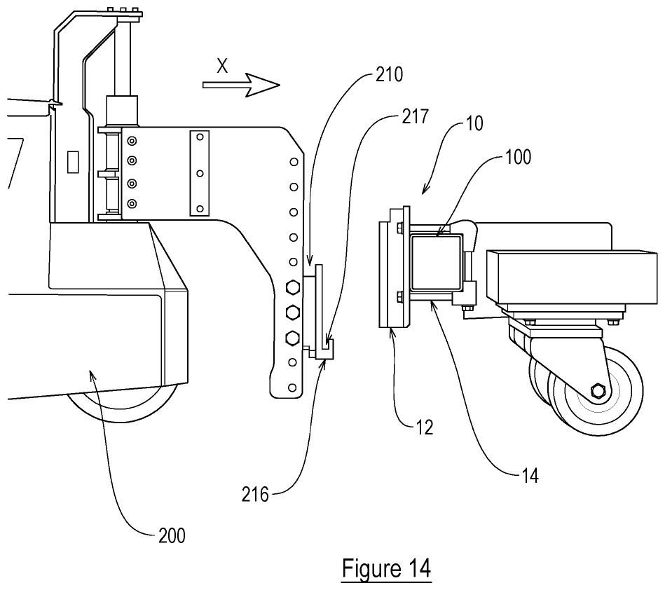

FIG. 14 is a side view showing an embodiment of the device according to the invention in use connecting a load to a load moving apparatus;

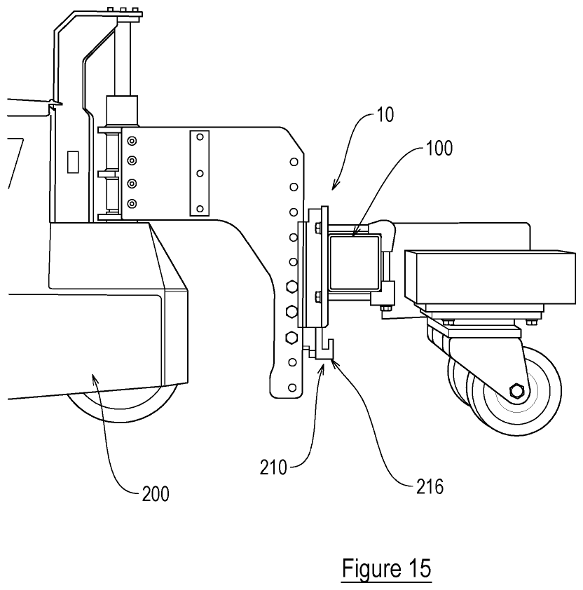

FIG. 15 is a further side view showing an embodiment of the device according to the invention in use connecting a load to a load moving apparatus;

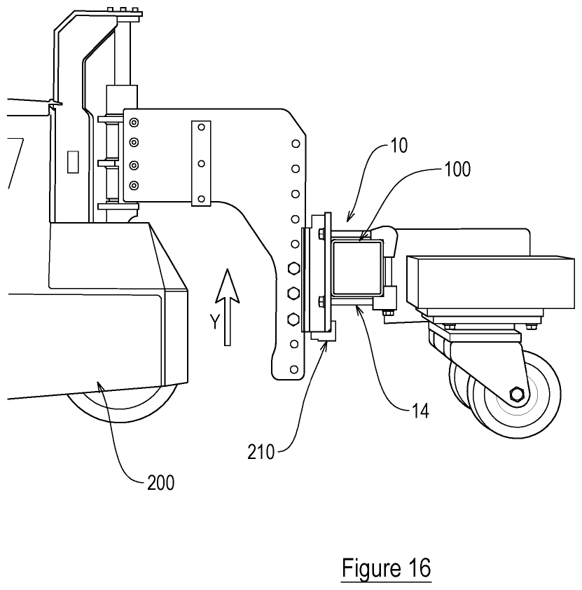

FIG. 16 is a yet further side view showing an embodiment of the device according to the invention in use connecting a load to a load moving apparatus.

With reference to FIGS. 1 to 16, a device 10 in accordance with embodiments of the present invention is shown. The device 10 has a main body 12 and a connection assembly 14. In the present embodiment, the device 10 is suitable for connecting to a load to enable a load moving apparatus 200 to move said load. The load moving apparatus 200 may include a drive system, such as an electric motor powered by a battery provided on the apparatus (or an electrical power source provided externally of the apparatus) or a motor/engine powered by other power sources such as combustible fossil fuels or hydrogen. Alternatively, the load moving apparatus 200 may not be driven by a power source and may be operated manually using force applied to the apparatus by a user.

In embodiments, the main body 12 further includes at least two surfaces, a first surface 12a which, in use, faces a part 100 of the load to be moved, and a second surface 12b which, in use, faces the load moving apparatus 200. In some embodiments, these surfaces 12a, 12b may be substantially planar. In other embodiments, these surfaces 12a, 12b may be non-planar or may be textured or knurled. In other embodiments, these surfaces 12a, 12b may include a material which is different to the material used to form the main body 12. For example, part of the surface 12, 12b may be formed from a material which is more pliable, or softer, than the material of the main body 12. In other examples, it may be made of a sacrificial material which may be replaced following a sufficient amount of wear. The main body 12 includes a connection formation 16 (in examples there may be a plurality of connection formations), which may be provided on the second surface 12b of the main body 12 which faces away from the part 100 of the load to be moved. In the present embodiment, the connection formation 16 may engage with a corresponding formation provided on a load moving apparatus 200, or provided on a part 210 which is connectable the load moving apparatus 200.

As shown in FIG. 12, the part 210 may include a main body 212 on which a corresponding connection formation 216 is provided. In the present example, the formation 216 is substantially L-shaped in side view and defines a channel 217 for receiving a lower edge portion of the main body 12. The part 210 may also include at least one connection element 218 provided on the main body 212 or a part attached to the main body 212. In use, the at least one connection element 218 may cooperate with a corresponding formation provided on the load moving apparatus 200. In the example shown in FIGS. 12 to 15, the connection element 218 may include a bolt which passes through the corresponding formation, such as an aperture or slot, of the load moving apparatus 200, and may be secured to the load moving apparatus 200 by a nut and washer. In embodiments, the nut may be a threaded nut which may or may not have a self-locking capability (such as a nylon-insert locking nut or the like), and the washer may be a flat washer, or it may be a washer with a locking capability such as a tooth washer or a wedge-locking washer, or other known locking washers.

The connection formation 16 and corresponding formation 216 of the load moving apparatus 200 may be complementary in shape, so as to enable the device 10 to be connected to a part 100 of the load to be moved to be interlocked with the part 210 (which is connected to the load moving apparatus 200) as exemplified in FIGS. 14 to 16. In some embodiments, the connection formations 16, 216 may be substantially hook-shaped or L-shaped. However, it should be appreciated that in other embodiments, the connection formations may formed in other shapes which allow them to interlock. The main body 12 may further include at least one guide formation 16a which in use provides for accurate alignment of the connection formation 16 of the device 10 and the corresponding formation 216 which is provided on the part 210 which connects to the load moving apparatus 200. As shown in FIG. 2, a portion of the at least one guide formation 16a may be inclined with respect the surface 12b which faces the load moving apparatus 200 such that, in use, when the load moving apparatus 200 is moved towards the load to be moved the part 210 connected to the load moving apparatus 200 contacts the guide formation 16a and may slide along it until the connection formation 16 of the device 10 and the corresponding formation 216 are substantially aligned. It should be appreciated that in other embodiments, the connection formation 16 and the corresponding formation 216 of the load moving apparatus may not interlock and may engage with each other by any suitable means. The main body 12 may also include at least one aperture 40, or a set of apertures 40, which will be discussed in more detail below.

In the present embodiment, the connection assembly 14 connects the main body 12 to the part 100 of a load to be moved. The part 100 of the load to be moved may be a permanent part of the load, such as a structural member or a part of the load designed to cooperate with the connection assembly 14. Alternatively, the part 100 of the load to be moved may be a part which is temporarily attached to the load for the purpose of cooperating with the connection assembly. It should be appreciated that in other embodiments, the connection assembly 14 may connect the main body 12 to a load moving apparatus 200, and the main body 12 may connect to a load to be moved by engaging the connection formation 16 with a corresponding formation provided on a part 100 of the load to be moved, or the main body 12 may connect to a part 10 of the load to be moved by other suitable means known to those skilled in the art.

In one embodiment, the connection assembly 14 includes a first engagement member 30a and a second engagement member 30b, as shown in FIGS. 3 to 11b. In other embodiments, as shown in FIG. 12, the connection assembly 14 also includes a third engagement member 30c in addition to the first engagement member 30a and second engagement member 30b (collectively referred to as engagement members 30 hereinafter). In use, the engagement members 30 may each engage with a portion of the part 100 of the load to be moved. In some embodiments, such as those exemplified in FIGS. 3 to 6, the engagement members 30 are substantially L-shaped (when viewed from the side) with two limbs that are oriented substantially perpendicularly to each other. However, it should be understood that the engagement members 30 may be shaped in other ways. In examples, two limbs may be oriented at angles which are not substantially perpendicular, or the engagement members 30 may have only one limb or more than two limbs. As shown in FIGS. 3 to 11b, the engagement members 30 may each include at least one engagement surface 36 which engages with a portion of the part 100 of a load to be moved. The engagement surface 36 may be shaped to substantially conform to the shape of a portion of a part 100 of the load to be moved. In some embodiments, as shown in FIGS. 3 to 6 and FIGS. 8 to 11b, the engagement surface 36 of at least one engagement member 30 is shaped so as to substantially conform to the shape (e.g. a corner) of the part 100 of a load which is substantially square or rectangular in cross-sectional profile, or cross-sectional profiles which may fit within the boundary of a square or rectangle including, but not limited to, the cross-sectional profiles of I-beams, H-beams, C-beams and U-beams. In other embodiments, the engagement surface 36 of at least one engagement member 30 is shaped so as to substantially conform to the shape of the part 100 of a load which is substantially circular or elliptical in cross-sectional profile, as shown in FIG. 7. In yet other embodiments, the engagement surface 36 of at least one engagement member 30 is shaped so as to substantially conform to a planar surface of the part 100 of a load, as exemplified in FIGS. 8 to 11b. In other embodiments, the engagement surface 36 may be shaped so as to substantially conform to any desired cross-sectional profiles, for instance those which take the form of an n-sided regular polygon or any other shape. In some embodiments, it is envisaged that at least a part of the engagement surface 36 may include a material which is different to the material used to form the engagement member 30. For example, part of the engagement surface 36 may be formed from a material which is more pliable, or softer, than the material of the engagement members 30. In other examples, it may be made of a sacrificial material which may be replaced following a sufficient amount of wear. Alternatively, in some embodiments the engagement surface 36 may be textured or knurled so as to enhance the frictional engagement between the engagement surface 36 and a portion of a part 100 of a load to be moved.

The connection assembly 14 further includes a plurality of adjustment members 20, each of which connects to at least one of the engagement members 30. In some embodiments, the adjustment members 20 may be directly connected to at least one of the engagement members 30, such as by the physical interaction or interconnection of corresponding parts of each member which is discussed in more detail below. In other embodiments, the adjustment members 20 may be directly connected to another part of the connection assembly 14 to which at least one of the engagement members 30 is also directly connected to. Each adjustment member 20 may have a shaft 26, which is generally elongate and extends along an elongate axis A. Each adjustment member 20 may also include an engaging formation 22 and a stop 24, the purposes of which will be discussed in more detail below. In embodiments, the connection assembly 14 includes an adjustment member 20 which connects to the first engagement member 30a. This adjustment member 20 also connects to the main body 12, thereby connecting the first engagement member 30a to the main body 12. The adjustment member 20 provides for adjustment of the position of the first engagement member 30a relative to the main body 12. The connection assembly 14 also includes a further adjustment member 20. In some embodiments, this further adjustment member 20 connects to the second engagement member 30b. This further adjustment member 20 also connects to the main body 12, thereby connecting the second engagement member 30b to the main body 12. In these embodiments, the further adjustment member 20 provides for adjustment of the position of the second engagement member 30b relative to the main body 12. In other embodiments, the further adjustment member 20 connects to both the first adjustment member 30a and to the second engagement member 30b. In these embodiments, the further adjustment member 20 provides for adjustment of the position of the first engagement member 30a and the second engagement member 30b relative to each other. In embodiments which include a third engagement member 30c, the further adjustment member 20 connects the third engagement member 30c to the first or second engagement member 30a, 30b. In these embodiments, the further adjustment member provides for adjustment of the position of the third engagement member 30c relative to the engagement member 30a, 30b to which it is connected.

In the present embodiment, as exemplified in the figures, the connection assembly may include three adjustment members 20, hereinafter referred to as a first adjustment member 20a, a second adjustment member 20b and a third adjustment member 20c. In use, the first adjustment member 20a extends over an upwardly facing portion of the part 100 of the load to be moved and connects the first engagement member 30a to the main body 12. The first adjustment member 20a provides for adjustment of the position of the first engagement member 30a in a direction substantially towards and away from the main body 12. The second adjustment member 20b extends under a downwardly facing portion of the part 100 of the load to be moved and connects the second engagement member 30b to the main body 12. The second adjustment member 20b provides for adjustment of the position of the second engagement member 30b in a direction substantially towards and away from the main body 12. In some embodiments, The third adjustment member 20c may extend over a portion of the part 100 of the load to be moved, said portion being opposite the first surface 12a of the main body 12 (and which in the example is substantially perpendicular to the upwardly and downwardly facing surfaces of the part 100). As shown in FIGS. 1 to 7, the third adjustment member 20c is positioned on a side of the part 100 of the load to be moved which is opposite the side of the part 100 of the load to be moved which faces and abuts the main body 12. In other words, the third adjustment member 20c may be positioned on a side of the main body 12 which faces the first surface 12a. In other embodiments, and for example with reference to FIGS. 8 to 11b, the third adjustment member 20c may positioned on a side of the main body 12 adjacent the second surface 12b which, in use, faces the load moving apparatus 200. This arrangement of the third adjustment member 20c may be advantageous when access to the side of the part 100 of the load to be moved which is opposite the side of the part 100 of the load which faces the first surface 12a of the main body 12 is hindered, obstructed or otherwise inaccessible. In some embodiments, the third adjustment member 20c provides for adjustment of the position of first and second engagement members 30a, 30b towards and away from each other. In embodiments which also include a third engagement member 30c, the third adjustment member 20c may provide for adjustment of the position of the third engagement member 30c.

The connection of the first and second adjustment members 20a, 20b to the main body 12 and the first and second engagement members 30a, 30b will now be explained. The main body 12 may include at least one aperture 40, 42 which provides a mounting location for the first and second adjustment members 20a, 20b. For examples, the main body 12 may include two apertures 40, each of which provides a mounting location for each of the first and second adjustment members 20a, 20b. Alternatively, the main body 12 may include only one aperture which is sized so as to provide a mounting location for both first and second adjustment members 20a, 20b. Each aperture 40 extends through the main body 12, in a direction which extends from the second surface 12b of the main body 12 which faces the load moving apparatus 200 to the first surface 12a of the main body 12 which faces the part 100 of the load to be moved.

As shown in the figures, each aperture 40 may be in the form of a substantially circular hole or may be in the form of an elongate aperture or slot 42. In embodiments, the main body 12 may include both a plurality of apertures 40 and at least one elongate slot 42. In some embodiments, the plurality of apertures 40 may be provided as a set of apertures 40 for one of the adjustment members 20 for permitting alternative mounting locations of said adjustment member 20 relative to the main body 12. With reference to the figures, the main body 12 may include a set of apertures 40 for at least one of the adjustment members 20 for permitting alternative mounting locations of said adjustment member 20 relative to the main body. For example, and with reference to the figures, the plurality of apertures 40 may provide alternative mounting locations for the second adjustment member 20b relative to the main body 12.

The number of possible mounting locations for the second adjustment member 20b is determined by the number of apertures 40 provided. In addition, and with reference to the figures, the main body 12 may also include an elongate slot 42 for adjustment of the position of the first adjustment member 20a relative to the main body 12. In embodiments, the elongate slot 42 provides for adjustment of the position of the first adjustment member 20a in a direction which is determined by the direction in which the slot 42 extends along the first/second surface 12a, 12b of the main body 12. For example, this direction may allow for slidable adjustment of the position of the first adjustment member 20a towards or away from the second adjustment member 20b, so as to increase or decrease the linear distance between the two adjustment members 20a, 20b. The first and second adjustment members 20a, 20b are mounted to the main body 12 by feeding the adjustment member 20a, 20b through the desired aperture 40 or elongate slot 42. In some embodiments, the stop 24 of the adjustment member 20 may serve to prevent the adjustment member 20 from being completely fed through the aperture 40, 42 in the main body 12. The stop 24 is also shaped so as to provide a means for enabling rotation of the adjustment member by a tool. Once mounted to the main body 12, the first and second adjustment members 20a, 20b extend away from the first surface 12a of the main body 12 which faces the part 100 of the load to be moved in a direction substantially perpendicular thereto and the stop 24 may be positioned adjacent, or in contact with the second surface 12b of the main body 12, or in contact with a part of the device 10 which is in contact with the second surface 12b of the main body 12.

Following the mounting of the first and second adjustment members 20a, 20b to the main body 12, the first and second engagement members 30a, 30b may be connected to their respective adjustment members 20. In embodiments, each adjustment member 20 may include an engaging formation 22 which engages with a corresponding engaging formation 32 provided on the engagement member 30 to which it is to be connected. The engaging formation 22 may extend along only a portion of the shaft 26 of the adjustment member 20, or it may extend along the full length of the shaft 26. As shown in the figures, each engagement member 30 may include at least one corresponding engaging formation 32. In some embodiments, the engaging formations 22 of the adjustment members 20 and the corresponding engaging formations 32 of engagement members 30 may include camming portions and/or threaded portions or the like.

With reference to FIG. 4, in embodiments wherein the engaging formations 22 of the adjustment members 20 and the engaging formations 32 of the engagement members 30 are corresponding threaded portions, the engaging formations 32 of the engagement members 30 may be placed in contact with the engaging formations 22 of the adjustment members 20. To connect the engagement members 30 to their respective adjustment member 20, either member can rotated relative to the other in such a manner which causes the threaded portions to commence engagement. As the engagement member 30a, 30b or respective adjustment member 20 is continuously rotated relative to the other, an increased length of the threaded portion of one of the adjustment member 20 or engagement member 30 will be engaged with the respective threaded portion of the other of the adjustment member 20 or engagement member 30. The direction of rotation required to cause engagement of the members is dependent on the way in which the threaded portions are formed, for example if the portions are formed of right-handed threads or left-handed threads. In other embodiments, the engagement members 30 may include an aperture 34 through which the engaging formation 22 of an adjustment member 20 may be at least partially fed through. In these embodiments, the engaging formation 22 of an adjustment member 20 which protrudes from the aperture 34 of the engagement member 30 may instead engage with a corresponding threaded portion provided on a securing element 50 which is provided separately to the engagement member 30, as shown in FIG. 6. The adjustment member 20 may be connected to the securing element 50 in a manner similar to that described above by the relative rotation of the adjustment member 20 relative to the securing element 50. The direction of rotation required to cause engagement of the adjustment member 20 and the securing element 50 is dependent on the way in which the threaded portions are formed, for example if the portions are formed of right-handed threads or left-handed threads. Continuous relative rotation of the adjustment member 20 and the securing element 50 will cause an increased length of the engaging formation 22 of the adjustment member 20 to engage with the threaded portion of the securing element 50. In this way, the position of the securing element 50 along the length of the adjustment member 20 may be modified. In use, a part of the securing element 50 may be brought into contact with a surface of the engagement member 30, which acts to at least partially retain the engagement member 30 in place relative to the adjustment member 20 to which it is connected. In embodiments, the securing element 50 may be a threaded nut which may or may not have a self-locking capability (such as a nylon-insert locking nut or the like). In yet further embodiments, the securing element 50 may be used in conjunction with a washer 60 which may be placed between a surface of the securing element 50 and a surface of the engagement member 30. In these embodiments, the washer 60 may be a flat washer or the like, or it may be a washer with a locking capability such as a tooth washer or a wedge-locking washer or other locking washers known to the skilled person. It is envisaged that in further embodiments, a resilient element, such as a spring or the like, may be provided between the first surface 12a of the main body 12 and a surface of the engagement member 30 which is opposite a surface of the engagement member 30 which is in contact with the securing element 50, which in use acts to urge the engagement member 30 towards the securing element 50.

In embodiments, once the adjustment members 20 are connected to respective engagement members 30, the adjustment members 20 may be used to adjust the position of the engagement members 30 relative to the main body 12. The adjustment of the position of the engagement members 30 relative to the main body 12 will be described with reference to the first adjustment member 20a and the first engagement member 30a. As the elongate axes A of the first and second adjustment members 20a, 20b are substantially parallel to each other, it should be appreciated that the adjustment of the position of the second engagement member 30b relative main body 12 may be performed in the same manner by operation of the second engagement member 30b. As shown in FIG. 2, the first adjustment member 20a may be rotated clockwise or anti clockwise about its elongate axis A. Rotation of the first adjustment member 20a about its elongate axis A causes movement of the connected first engagement member 30a along a path B which is substantially parallel to the elongate axis A of the first adjustment member 20a. As elongate axis A and path B are substantially perpendicular to the first surface 12a of the main body 12, the first engagement member 30a will be caused to move towards or away from the main body 12 dependent on the direction of rotation of the first adjustment member 20a. The direction of movement of the first engagement member 30a along the path B is dependent on the direction of rotation of the first adjustment member 20a. In some embodiments where the engaging formation 22 of the first adjustment member 20a and the engaging formation 32 of the first engagement members 30a are corresponding right-handed threaded portions, clockwise rotation of the first adjustment member 20a when viewed from the end of the adjustment member which includes the stop 24 will cause movement of the first engagement member 30a towards the main body 12. Conversely, anticlockwise rotation of the first adjustment member 20a will cause movement of the first engagement member 30 away from the main body 12.

In some embodiments, and with reference to the figures, the third adjustment member 20c of the connection assembly 14 may be connected to both the first and second engagement members 30a, 30b so as to connect them to each other. In embodiments which include a third engagement member 30c, the third adjustment member 20c of the connection assembly 14 may be connected to third engagement member 30c and one of the first or second engagement members 30a, 30b so as to connect them to each other. In embodiments, one of the engagement members may include an engaging formation 32 and the other of the engagement members 30may include an aperture 34.

Connection of the first and second engagement members 30a, 30b together will now be described by way of example. With particular reference to FIG. 5, in some embodiments the first engagement member 30 may include an engaging formation 32, which enables it to be connected to the third adjustment member 20c. This engaging formation 32 may be provided in addition to the engaging formation 32 described above which engages with the engaging formation 22 of the first adjustment member 20a and may be oriented in a direction which is substantially perpendicular to the direction of the engaging formation 32 corresponding to the engaging formation 22 of the first adjustment member 20a. However, it should be understood that the engaging formations 32 of the first engagement member 30a may be oriented in directions which are not substantially perpendicular, dependent upon the desired shape of the first engagement member 30a and/or the desired arrangement of the connection assembly 14. The second engagement member 30b may include an aperture 34 which enables the engaging formation 22 and the shaft 26 of the third adjustment member 20c to be fed through the second engagement member 30b until the stop 24 of the third adjustment member 20c is placed adjacent to or is in contact with a surface of the second engagement member 30b. This aperture 34 may be provided in addition to the engaging formation 32 described above which engages with the engaging formation 22 of the second adjustment member 20b and may be oriented in a direction which is substantially perpendicular to the direction of the engaging formation 32 corresponding to the engaging formation 22 of the second adjustment member 20b. However, it should be understood that the aperture 34 engaging formation 32 of the second engagement member 30b may be oriented in directions which are not substantially perpendicular, dependent upon the desired shape of the second engagement member 30b and/or the desired arrangement of the connection assembly 14.

To connect the first and second engagement members 30a, 30b, the third adjustment member 20c is fed through the aperture 34 of the second engagement member 30b until the engaging formation 32 of the third adjustment member 20c is placed in contact with the corresponding engaging formation 32 of the first engagement member 30a. The third adjustment member 20c may then be connected to the first engagement member 30a in same manner as the connection of the first and second adjustment members 20a, 20b with their respective engagement members 30 as described above.

Once connected together, the position of the first engagement member 30a relative to second engagement member 30b may be adjusted by manipulation of the third adjustment member 20c. As shown in FIG. 5, in embodiments the third adjustment member 20c may be rotated clockwise or anti clockwise about its elongate axis A. Rotation of the third adjustment member 20c about its elongate axis A causes movement of the connected first engagement member 30a along a path C which is substantially parallel to the elongate axis A of the third adjustment member 20a. In embodiments, the elongate axis A of the third adjustment member 20c and path C are substantially perpendicular to the elongate axes A of the first and second adjustment members 20a, 20b and are substantially parallel with the first surface 12a of the main body 12. The first engagement member 30a will be caused to move towards or away from the second engagement member 30b dependent on the direction of rotation of the third adjustment member 20c. The direction of movement of the first engagement member 30a along the path C is dependent on the direction of rotation of the third adjustment member 20a.

In some embodiments where the engaging formation 22 of the third adjustment member 20c and the engaging formation 32 of the first engagement member 30a are corresponding right-handed threaded portions, clockwise rotation of the third adjustment member 20c when viewed from the end of the adjustment member which includes the stop 24 will cause movement of the first engagement member 30a towards the second engagement member 30b. Conversely, anticlockwise rotation of the third adjustment member 20c will cause movement of the first engagement member 30 away from the second engagement member 30b.

It should be understood that in other embodiments, the aperture 34 may instead be provided on the first engagement member 30a, and the engaging formation 32 may instead be provided on the second engagement member 30bc, meaning that rotation of the third adjustment member 20c will cause movement of the second engagement member 30b towards and away from the first engagement member 30a. Additionally, adjustment of the position of the first and second engagement members 30a, 30b relative to the main body 12 based on rotation of the first and second adjustment members 20a, 20b will also result in the adjustment of the position of third adjustment member 20c relative to the main body 12.

As discussed above, in some embodiments the third adjustment member 20c may be provided on a side of the main body 12 adjacent the second surface 12b which faces the load moving apparatus 200. In such embodiments, the third adjustment member 20c may directly or indirectly (i.e. via other component parts) connect the first and second engagement members 30a, 30b to each other. With particular reference to FIGS. 8 to 11b, the device 10 may further include at least one connection element 70, which in use connects the third adjustment member 20c to the first and second adjustment members 20a, 20b which are each connected to the first and second engagement members 30a, 30b. In the example shown in FIGS. 8 to 11b, the device 10 may include first and second connection elements 70a, 70b. The first connection element 70a may include two channels 72 which are oriented substantially perpendicularly to each other and which are configured to receive the shaft 26 of an adjustment member 20 and allow it to be fed through. In use, the shaft 26 of the first adjustment member 20a is fed through one of the channels 72 and subsequently fed through an aperture 40 or slot 42 of the main body 12 so that it may connect to the first engagement member 30a in the manner described above, until the stop 24 is brought into contact with a surface of the first connection element 70a.

In this manner, the first connection element 70a is held in place between the stop 24 of the first adjustment member 20a and the second surface 12b of the main body 12. The second connection element 70b may include two channels 72, one of which is configured to receive the shaft 26 of an adjustment member 20. The other of the channels 72 may include a threaded portion which is configured to engage with the threaded portion of the engaging formation 22 of an adjustment member 20. In use, the shaft 26 of the second adjustment member 20b is fed through the channel 72 which does not include a threaded portion and subsequently fed through an aperture 40 or slot 42 of the main body 12 so that it may connect to the second engagement member 30a in the manner described above, until the stop 24 is brought adjacent to, or into contact with, a surface of the second connection element 70b. In this manner, the second connection element 70b is held in place between the stop 24 of the second adjustment member 20b and the second surface 12b of the main body 12.

To connect the first and second connection elements 70a, 70b to each other, the shaft 26 of the third adjustment member 20c is fed through the other channel 72 of the first connection element 70a not occupied by the first adjustment member 20a until the engaging formation 22 is brought into contact with the channel of the second connection element 70b which includes a threaded portion and is not occupied by the second adjustment member 20b, as shown in FIG. 11a. The third adjustment member 20c may be connected to the second connection element 70b by the relative rotation of the third adjustment member 20c relative to the second connection element 70b. The direction of rotation required to cause engagement of the third adjustment member 20c and the second connection element 70b is dependent on the way in which the threaded portions are formed, for example if the portions are formed of right-handed threads or left-handed threads. Continuous rotation of the third adjustment member 20c relative to the second connection element 70b will cause an increased length of the engaging formation 22 of the third adjustment member 20c to engage with the threaded portion of the second connection element 70b.

In this way, the first and second connection elements 70a, 70b may be connected to each other, and the position of the second connection element 70b with respect to the first connection element 70a may be modified. As the first and second adjustment members 20a, 20b are connected to the connection elements 70a, 70b, the relative position of the first and second adjustment members 20a, 20b, and therefore the position of the connected first and second engagement members 30a, 30b may be modified. It should be understood that although the aforementioned connection elements 70a, 70b have been described as being positioned adjacent or in contact with the second surface 12b of the main body 12, they could be positioned elsewhere. It is envisaged that in other embodiments, the third adjustment member 20c may be provided on or adjacent the side 12a of the main body 12.

In some embodiments, at least one of the connection elements 70a, 70b may include a further channel 73 which may accommodate an alignment member 80, and which extends along an axis D which is substantially parallel to the axis A. With particular reference to FIGS. 8 to 11b, the alignment member 80 may be at least partially fed through the channel 73 of the connection element 70a, 70b, and may be held in place by the use of a fastener 82 such as a set screw or the like. It may then subsequently be fed through an aperture 40 or slot 42 provided on the main body 12. It may then subsequently be fed through a passage 35 on an engagement member 30 which is connected to the adjustment member 20 which is connected to the connection element 70. In use, the alignment member 80 prevents or at least inhibits rotation of the connected engagement member 30.

With particular reference to FIG. 12, in some embodiments the third engagement member 30c may include an engaging formation 32, similar to the first and second engagement members 30a, 30b, which enables it to be connected to the third adjustment member 20c. The first engagement member 30a may include an aperture 34, which enables the engaging formation 22 and the shaft 26 of the third engagement member 20c to be fed through the first engagement member 30a until the stop 24 of the third adjustment member 20c is placed adjacent to, or is in contact with, a surface of the first engagement member 30a. This aperture 34 may be provided in addition to the engaging formation 32 described above which engages with the engaging formation 22 of the first adjustment member 20a and may be oriented in a direction which is substantially perpendicular to the direction of the engaging formation 32 corresponding to the engaging formation 22 of the first adjustment member 20a. However, it should be understood that the aperture 34 and the engaging formation 32 of the first engagement member 30a may be oriented in directions which are not substantially perpendicular, dependent upon the desired shape of the first engagement member 30a and/or the desired arrangement of the connection assembly 14.

To connect the first and third engagement members 30a, 30c, the third adjustment member 20c is fed through the aperture 34 of the first engagement member 30a until the engaging formation 32 of the third adjustment member 20c is placed in contact with the corresponding engaging formation 32 of the third engagement member 30c. The third adjustment member 20c may then be connected to the third engagement member 30c by the relative rotation of the third adjustment member 20c relative to the third engagement member 30c in a manner similar to that described above for similar connections between adjustment members 20 and engagement members 30.

Once connected together, the position of the third engagement member 30c relative to first engagement member 30a may be adjusted by manipulation of the third adjustment member 20c. The third adjustment member 20c may be rotated clockwise or anti clockwise about its elongate axis A. Rotation of the third adjustment member 20c about its elongate axis A causes movement of the connected third engagement member 30c along a path C which is substantially parallel to the elongate axis A of the third adjustment member 20c. In embodiments, the elongate axis A of the third adjustment member 20c and path C are substantially perpendicular to the elongate axes A of the first and second adjustment members 20a, 20b and are substantially parallel with the first surface 12a of the main body 12. The third engagement member 30c will be caused to move towards or away from the first engagement member 30a dependent on the direction of rotation of the third adjustment member 20c. The direction of movement of the third engagement member 30c along the path C is dependent on the direction of rotation of the third adjustment member 20c.

It should be understood that in other embodiments, the aperture 34 may instead be provided on the third engagement member 30c, and the engaging formation 32 may instead be provided on the first engagement member 30a. Additionally, adjustment of the position of the first engagement members 30a relative to the main body 12 based on rotation of the first adjustment member 20a will also result in the adjustment of the position of third adjustment member 20c relative to the main body 12. It should also be understood that in alternative embodiments the third engagement member 20c may instead be connected to the second engagement member 20b in a manner similar to that described above for connecting the first and third engagement members 20a, 20c.

As shown in FIG. 12, the inclusion of a third engagement member 30c enables a portion of the part 100 of the load to be moved to be held or clamped between an engagement surface 36 of the third engagement member 30c and an engagement surface 36 of the engagement member 30a, 30b to which the third engagement member 30c is connected to. This is particular advantageous when the connection assembly 14 is required to connect to a part 100 of a load to be moved of which the cross-sectional profile has limbs or appendages (such as L-shaped profiles), or is otherwise irregular in shape.

Advantageously, the combination of the adjustment members 20 and the apertures 40 and/or slots 42 of the main body allow the positioning of each of the engagement members 30 to be adjusted in two dimensions. This enables the user of the device 10 to configure and reconfigure the connection assembly 14 so that it may connect the device 10 to different parts of a load to be moved or to different loads to be moved.

In use, the user may connect an already assembly connection assembly 14 so that the engagement members 30 and the first surface 12a of the main body 12 do not contact or engage with the part 100 of the load to be moved. The user may then manipulate each of the adjustment members 20 so that the engagement members 30 engage with the part 100 of the load to be moved. The user may also choose to adjust the connection assembly so that the first surface 12a of the main body 12 may engage with the part 100 of the load to be moved. In addition, the adjustment members 20 may be manipulated so that the engagement members 30 and the first surface 12a if the main body 12 do or do not apply a clamping force to the part 100 of the load, dependent on whether or not the user wishes to use the connection assembly 14 to clamp the device 10 to the part 100 of the load.

The inclusion of three adjustment members 20 also creates a closed profile or boundary in which the part 100 of the load to be moved is retained. This may serve to prevent the part 100 of the load from escaping the connection assembly 14, whilst also providing a rigid structure which is secured to the main body 12 in two locations preventing splaying or unwanted movement of the engagement members 30. Furthermore, in some embodiments, and with reference to the figures, the device 10 may include two or more connection assemblies 14, each including some or all of the features described above. These two or more connection assemblies 14 may be spaced apart from each other along a part of a load to be moved, enhancing the connection between the device 10 and the load to be moved.

Once the device 10 is connected to a part 100 of the load to be moved, the device 10 may then be connected to the load moving apparatus 200. With reference to FIGS. 14 to 16, the load moving apparatus 200 may include a part 210 which interlocks with the device 10 which is connected to a part 100 of the load to be moved. As shown in FIG. 14, the load moving apparatus 200 may be manoeuvred towards the load to be moved along a substantially horizontal direction X so as to bring the part 210 closer to the device 10. The devices 10, 210 may then be brought close to each other, or into contact, and may be substantially aligned, as shown in FIG. 15. With reference to FIG. 16, a part of the load moving apparatus 200 onto which the part 210 is connected may be translated in a substantially vertical direction Y so as to draw the connection formations 16, 216 of the devices 10, 210 closer to each other, until both devices 10, 210 interlock. In some embodiments, the connection formation 16 may engage with a part of the part 210 connected to the load moving apparatus 200, such as the main body 212, and the connection formation 216 of the part 210 connected to the load moving apparatus 200 may engage with a part of the device 10 connected to the part 100 of the load to be moved, such as the main body 12, thus providing a strong interlocking connection between the devices 10, 210. In other embodiments, the connection formation 16 of the device 10 connected to a part 100 of the load to be moved may engage directly with the connection formation 216 of the part 210 connected to the load moving apparatus to provide the interlocking connection between the devices 10, 210.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A device for connecting to a load to be moved, the device including:
a main body having a connection formation for engaging with a corresponding formation provided on a load moving apparatus;
a connection assembly for connecting the main body to a part of the load to be moved, including:
first and second engagement members for engaging with respective portions of the part of the load to be moved,
an adjustment member connecting the first engagement member to the main body and providing for adjustment of the position of the first engagement member relative to the main body,
a further adjustment member connecting the second engagement member to the main body and providing for adjustment of the position of the second engagement member relative to the main body.

2. A device according to claim 1 including a further adjustment member connecting the first engagement member to the second engagement member and providing for adjustment of the position of the first and second engagement members relative to each other.

3. A device for connecting to a load to be moved, the device including:
a main body having a connection formation for engaging with a corresponding formation provided on a load moving apparatus;
a connection assembly for connecting the main body to a part of the load to be moved, including:
first and second engagement members for engaging with respective portions of the part of the load to be moved,
an adjustment member for connecting the first or second engagement member to the main body and providing for adjustment of the position of the first or second engagement member relative to the main body,
a further adjustment member connecting the first engagement member to the second engagement member and providing for adjustment of the position of the first and second engagement members relative to each other.

4. A device according to claim 3 including a further adjustment member for connecting the other of the first or second engagement member to the main body and providing for adjustment of the position of the first or second engagement member relative to the main body.

5. A device for connecting to a load to be moved, the device including:
a main body having a connection formation for engaging with a corresponding formation provided on a load moving apparatus;
a connection assembly for connecting the main body to a part of the load to be moved, including:
first, second and third engagement members for engaging with respective portions of the part of the load to be moved,
an adjustment member for connecting the first or second engagement member to the main body and providing for adjustment of the position of the first or second engagement member relative to the main body,
a further adjustment member connecting the other of the first or second engagement member to the main body and providing for adjustment of the position of the second engagement member relative to the main body,
a further adjustment member connecting the first or second engagement member to the third engagement member and providing for adjustment of the position of the third engagement members relative to the engagement member to which it is connected.

6. A device according to claim 1 wherein:
one of the adjustment members (hereinafter referred to as the first adjustment member) extends over an upwardly facing portion of the part of the load to be moved, and wherein
one of the adjustment members (hereinafter referred to as the second adjustment member) extends under an downwardly facing portion of the part of the load to be moved, and wherein
one of the adjustment members (hereinafter referred to as the third adjustment member) extends over a portion of the part of the load to be moved, said portion being opposite the main body.

7. A device according to claim 1 wherein:
the adjustment member which connects the first engagement member to the main body provides for adjustment of the position of the first engagement member towards and away from the main body, and wherein
the adjustment member which connects the second engagement member to the main body provides for adjustment of the position of the second engagement member towards and away from the main body.

8. A device according to claim 2 wherein:
the adjustment member which connects the first and second engagement members to each other provides for adjustment of the position of first and second engagement members towards and away from each other.

9. A device according to claim 1 wherein the main body includes respective mounting locations for the first and second adjustment members, each mounting location preferably including an aperture through which a portion of the respective adjustment member extends.

10. A device according to claim 9 wherein the main body includes a set of apertures for at least one of the adjustment members for permitting alternative mounting locations of said adjustment member relative to the main body.

11. A device according to claim 9 wherein at least one of the apertures is an elongate slot or the like which permits a position of the respective adjustment member relative to the main body to be slidably adjusted.

12. A device according to claim 1 wherein each adjustment member includes an engaging formation which engages with a corresponding engaging formation provided on the engagement member to which it is connected, preferably wherein said engagement formations are or include camming portions and/or threaded portions or the like.

13. A device according to claim 1 wherein each adjustment member is generally elongate and has an elongate axis, and wherein rotation of the adjustment member about its elongate axis effects movement of the engagement member to which it is connected.

14. A device according to claim 13 wherein the elongate axes of the first and second adjustment members are substantially parallel with each other.

15. A device according to claim 13 further including a further adjustment member (hereinafter referred to as the third adjustment member) connecting the first engagement member to the second engagement member and providing for adjustment of the position of the first and second engagement members relative to each other, and wherein the elongate axis of the third adjustment member, which adjustment member connects to the first engagement member and/or second engagement member, is substantially perpendicular to the elongate axis of one or both of the elongate axes of the first and second adjustment members.

16. A device according to claim 13 wherein the main body includes a surface which faces and preferably in use engages with the part of the load to be moved, and wherein the elongate axes of the first and second adjustment members extends away from said surface in a direction substantially perpendicular thereto.

17. A device according to claim 13 further including a further adjustment member (hereinafter referred to as the third adjustment member) connecting the first engagement member to the second engagement member and providing for adjustment of the position of the first and second engagement member relative to each other, and wherein the main body includes a surface which faces and preferably in use engages with the part of the load to be moved, and wherein the elongate axis of the third adjustment member is substantially parallel with said surface.

18. A device according to claim 1 wherein a part of one or more of the engagement members is shaped so as to substantially conform to a portion of the part of the load to be moved.

19. A device according to claim 1 wherein the connection formation of the main body is provided on a surface of the main body which faces away from the part of the load to be moved.

20. A device according to claim 1 including two or more of said connection assemblies each including any the features as set out in any of the preceding claims, wherein the connection assemblies are spaced from each other along the part of the load to be moved.
